(19) United States
(12) Patent Application Publication
(10) Pub. No.: US 2017/0331857 A1
(43) Pub. Date: Nov. 16, 2017

(54) NON-TRANSITORY RECORDING MEDIUM STORING DATA PROTECTION PROGRAM, DATA PROTECTION METHOD, AND DATA PROTECTION APPARATUS

(71) Applicant: FUJITSU LIMITED, Kawasaki-shi (JP)

(72) Inventors: Kazuyoshi Furukawa, Kawasaki (JP); Hirotaka KOKUBO, Minato (JP); TAKANORI OIKAWA, Kawasaki (JP); Masahiko TAKENAKA, Kawasaki (JP)

(73) Assignee: FUJITSU LIMITED, Kawasaki-shi (JP)

(21) Appl. No.: 15/428,225

(22) Filed: Feb. 9, 2017

(30) Foreign Application Priority Data
May 12, 2016 (JP) 2016-095960

(51) Int. Cl. H04L 29/06; G06F 9/455; G06F 3/06

(52) U.S. Cl. CPC H04L 63/1491; H04L 63/145; G06F 9/45558; G06F 3/065; G06F 3/0619; G06F 3/067; G06F 3/0659; G06F 2009/45583; H04L 63/02

(57) ABSTRACT

A non-transitory recording medium storing a data protection program causing a computer to perform a process, the process includes: storing, in a memory, a first command to be transmitted from a malware to an operating system; hooking a second command that has been transmitted from an application to the operating system; determining whether the second command is stored in the memory; and switching a destination of writing data by the operating system from a first hardware to a second hardware when the second command is stored in the memory.

### CROSS-REFERENCE TO RELATED APPLICATION

This application is based upon and claims the benefit of priority of the prior Japanese Patent Application No. 2016-095960, filed on May 12, 2016, the entire contents of which are incorporated herein by reference.

### FIELD

The embodiment discussed herein is related to a non-transitory recording medium storing a data protection program, a data protection method, and a data protection apparatus.

### BACKGROUND

A security administrator (hereinafter simply referred to as an administrator) in a company or organization makes an effort to control illegal acquisition or destruction of information (hereinafter referred to as an unscrupulous activity) by using a program (hereinafter referred to as malware) performing a harmful action, such as a computer virus.

Related art techniques are disclosed in Japanese Laid-open Patent Publication Nos. 2015-130162 and 2013-545208.

### SUMMARY

According to an aspect of the embodiments, a non-transitory recording medium storing a data protection program causing a computer to perform a process, the process includes: storing, in a memory, a first command to be transmitted from a malware to an operating system; hooking a second command that has been transmitted from an application to the operating system; determining whether the second command is stored in the memory; and switching a destination of writing data by the operating system from a first hardware to a second hardware when the second command is stored in the memory.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is an example of an information processing system;

FIG. 2 illustrates an example of a configuration in which an unscrupulous person transmits malware to a terminal apparatus;

FIG. 3 illustrates a hardware configuration of a terminal apparatus;

FIG. 4 illustrates an example of a functional block of the terminal apparatus;

FIG. 5 illustrates an example of a data protection process;

FIG. 6 illustrates an example of the data protection process;

FIG. 7 illustrates an example of a functional configuration of the terminal apparatus;

FIG. 8 illustrates an example of the functional configuration of the terminal apparatus;

FIG. 9 illustrates an example of the functional configuration of the terminal apparatus;

FIG. 10 illustrates an example of a data protection process;

FIG. 11 illustrates an example of the data protection process;

FIG. 12 illustrates an example of the data protection process;

FIG. 13 illustrates an example of the data protection process;

FIG. 14 illustrates an example of command information;

FIG. 15 illustrates an example of the data protection process;

FIG. 16 illustrates an example of the data protection process;

FIG. 17 illustrates an example of the data protection process;

FIG. 18 illustrates an example of the command information; and

FIG. 19 illustrates an example of an operation in S42 (operation in S72).

### DESCRIPTION OF EMBODIMENT

Ransomware included in malware is transmitted together with an e-mail to an external terminal apparatus (hereinafter simply referred to as an external terminal) in a form attached to the e-mail by an unscrupulous person. When the ransomware is executed on the terminal apparatus that has received the e-mail, files on the terminal apparatus are encrypted. The unscrupulous person who has sent the e-mail with the ransomware attached thereto demands a payment for a decryption key to decrypt the encrypted files.

An administrator pre-installs anti-virus software on each terminal apparatus (such as a terminal apparatus storing an important file). The administrator may be able to reduce damage caused by the malware, such as the ransomware.

The malware that is executed on the terminal apparatus includes a new type of malware that the anti-virus software is not designed to respond to or detect. For this reason, the anti-virus software may not be able to detect the malware that has been executed on the terminal apparatus.

If the terminal apparatus has acquired backup data, the administrator rolls the terminal apparatus back to a phase before the terminal apparatus is not yet damaged by the malware. In this way, even if a file has been encrypted, the administrator obtains a file that is not yet encrypted.

If the terminal apparatus has rolled back, contents of a job that has been performed during the rollback are lost. If a time period during which the backup data is obtained on the terminal apparatus is longer, an amount of the lost contents of the job caused by the rollback may be larger.

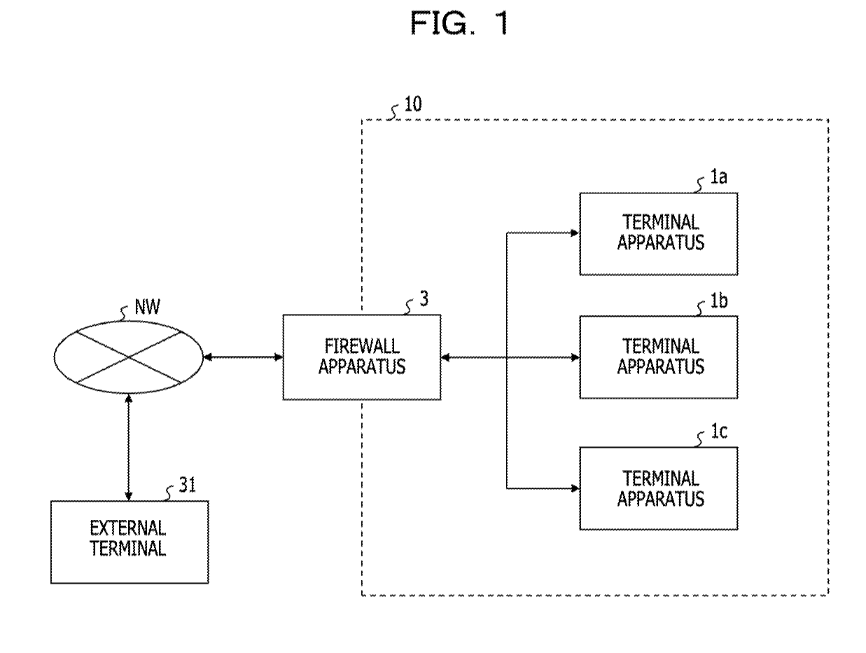

FIG. 1 illustrates an example of an information processing system 10. The information processing system 10 of FIG. 1 includes terminal apparatuses 1a, 1b, and 1c (these apparatuses are collectively referred to as a terminal apparatus 1 or a data protection apparatus 1), and a firewall apparatus 3.

The terminal apparatus 1 is a terminal that is used by a job system developer or an administrator in a company or organization. For example, the terminal apparatus 1 is a desk-top personal computer (PC) or a notebook PC.

The firewall apparatus 3 controls communication between an external terminal 31 connected to a network NW and a terminal apparatus 1. The firewall apparatus 3 protects the terminal apparatus 1 from an unauthorized access from the external terminal 31. The network NW is the Internet, for example.

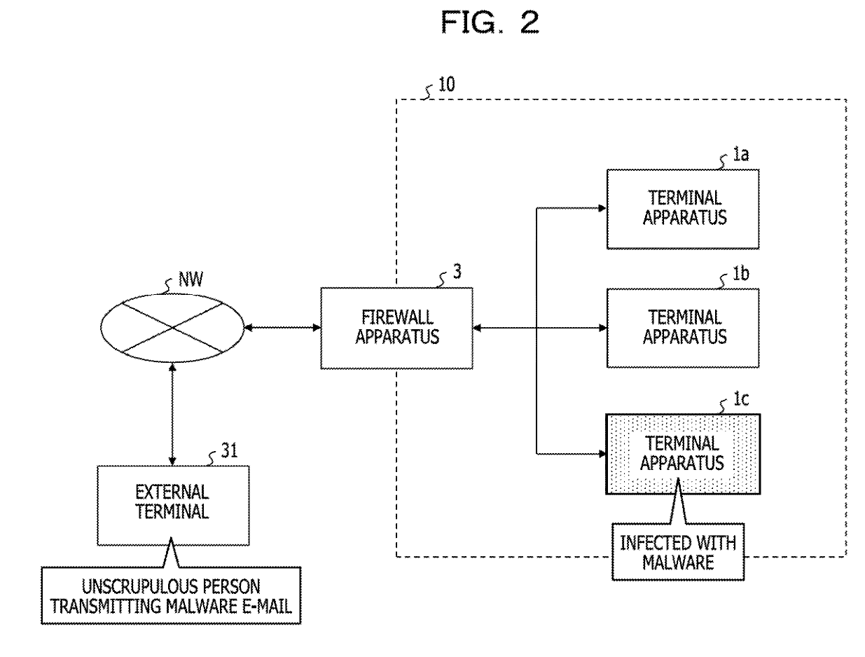

FIG. 2 illustrates an example of a configuration in which an unscrupulous person transmits malware to the terminal apparatus 1.

An unscrupulous person may transmit to the terminal apparatus 1c an e-mail with malware attached thereto (e-mail that looks like an e-mail with an executable file attached thereto) via the external terminal 31 as illustrated in FIG. 2. For example, the unscrupulous person decides a target (a specific company, for example) from which he or she wants to illegally obtain information, and then transmits an e-mail with malware attached thereto to a target terminal apparatus, such as the terminal apparatus 1c of FIG. 1 (this action is hereinafter also called a targeted attack).

In this case, the firewall apparatus 3 may not determine that malware is not attached to the e-mail transmitted from the external terminal 31 and may not discard that e-mail. For example, the terminal apparatus 1c of FIG. 1 may be infected with the malware when a user executes the malware attached to the transmitted e-mail as illustrated in FIG. 2.

The administrator may pre-install anti-virus software on each terminal apparatus (such as the one that stores an important file). If the contents of an operation of an application functioning on the terminal apparatus 1 are identical to the contents of the operation of malware that was analyzed in the past, the anti-virus software determines that the application is infected with the malware, and then rejects the malware. The administrator may reduce the damage caused by the malware, such as ransomware.

However, the malware to be executed on the terminal apparatus 1 may be a new type of malware (malware that the anti-virus software does not respond to). For example, the malware executed on the terminal apparatus 1 may be malware that does not perform an operation that the anti-virus software is able to detect. In such a case, the administrator may not detect the malware that has been executed on the terminal apparatus 1.

If the terminal apparatus 1 has obtained backup data, the administrator rolls the terminal apparatus 1 back to a phase before the terminal apparatus 1 is damaged by the malware. Even after the terminal apparatus 1 is damaged by the malware, the administrator may obtain a file free from the damage.

If the rollback is performed on the terminal apparatus 1, the contents of a job performed during a time period of the rollback are lost. For example, if a time period during which the backup data is acquired on the terminal apparatus 1 is longer, an amount of contents of the job lost during the rollback may be larger.

A hypervisor of the terminal apparatus 1 pre-stores on a memory a command that may be transmitted from the malware to an operating system (OS). The hypervisor of the terminal apparatus 1 hooks a command transmitted from an application to the OS (hereinafter referred to as a specific command). If the hooked command is stored on the memory, the hypervisor of the terminal apparatus 1 switches data writing destinations of the OS from current hardware to other hardware.

If the command transmitted to the OS from the application running on the OS is identical to the command stored on the memory, the hypervisor of the terminal apparatus 1 determines that the application that has transmitted the malware is the malware itself, or that the application is infected with the malware. In such a case, the hypervisor of the terminal apparatus 1 switches data writing hardware destinations of the OS.

The hypervisor of the terminal apparatus 1 may reduce the possibility that the hardware before switching is operated by the malware (the application infected with the malware). The hypervisor of the terminal apparatus 1 may reduce damage, for example, damage that data stored on the hardware before switching is encrypted by the malware.

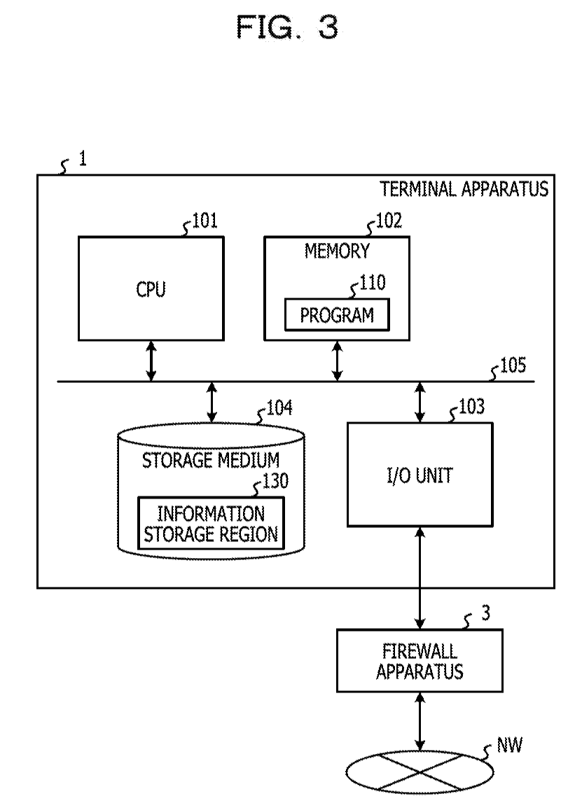

FIG. 3 illustrates a hardware configuration of the terminal apparatus 1.

The terminal apparatus 1 includes a central processing unit (CPU) 101, a memory 102, an external communication interface (input and output (I/O) unit) 103, and a storage medium 104. These elements are interconnected via a bus 105.

The storage medium 104 stores a program 110 that performs a process to protect data on a program storage region in the storage medium 104 from the malware (hereinafter referred to as a data protection process). The storage medium 104 may be a hard disk drive (HDD) or a solid state drive (SDD).

Referring to FIG. 3, during executing the program 110, the CPU 101 loads the program 110 from the storage medium 104 to the memory 102, and performs the data protection process or another process in cooperation with the program 110.

The storage medium 104 includes a data storage region 130 configured to store information used when the data protection process or another process (hereinafter also referred to as a storage unit 130). The storage unit 130 may operate as a memory that is controlled by the hypervisor of the terminal apparatus 1.

The external communication interface 103 communicates with the network NW via the firewall apparatus 3.

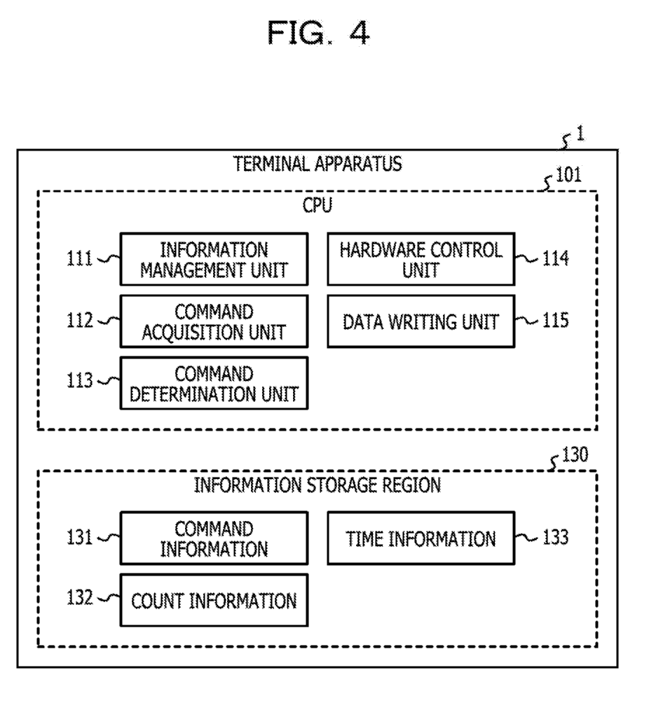

FIG. 4 illustrates an example of a functional block of the terminal apparatus 1. The terminal apparatus 1 of FIG. 4 may be the terminal apparatus of FIG. 3. By working in cooperation with the program 110, the CPU 101 functions as an information management unit 111 serving as the hypervisor of the terminal apparatus 1, a command acquisition unit 112, a command determination unit 113, a hardware control unit 114 (hereinafter also referred to as a switching unit 114), and a data writing unit 115. The information storage region 130 stores command information 131, count information 132, and time information 133.

The information management unit 111 stores a command, which may be possibly transmitted from the malware to the OS, on the information storage region 130 as the command information 131.

The command acquisition unit 112 hooks the command transmitted from the OS to the hardware. The command determination unit 113 determines whether information corresponding to the command hooked by the command acquisition unit 112 is included in the command information 131 stored on the information storage region 130.

If the command determination unit 113 determines that the information corresponding to the command hooked by the command acquisition unit 112 is included in the command information 131, the hardware control unit 114 stores the data, stored on the hardware, on other hardware.

The data writing unit 115 writes the data on the other hardware in response to a command transmitted from the application to the OS (hereinafter also referred to as a write request). The following discussion is based on the premise that the other hardware is the storage medium 104. The other hardware may be another storage medium different from the storage medium 104. The other hardware may be another memory different from the memory 102.

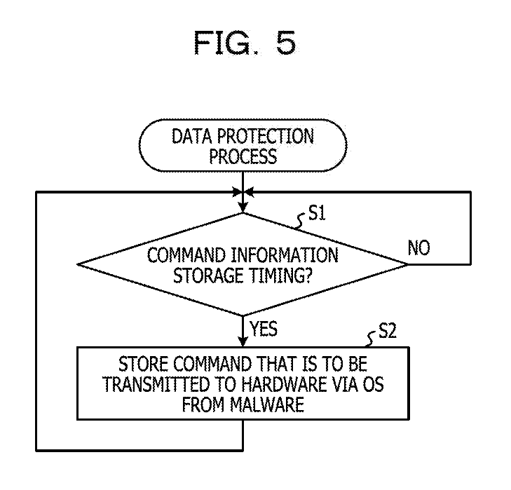

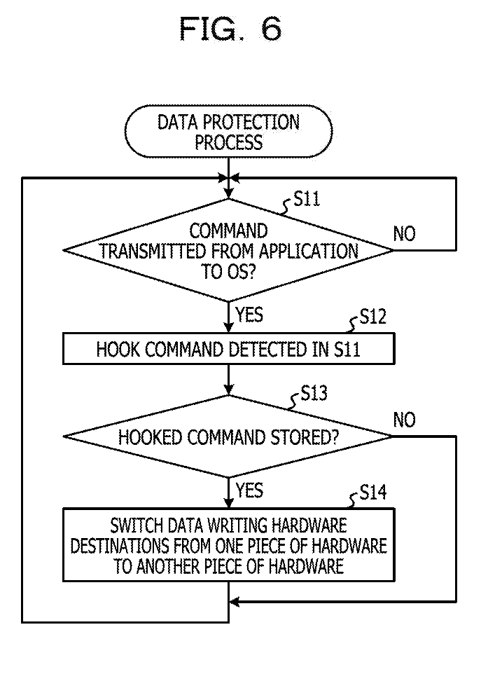

FIG. 5 and FIG. 6 illustrate examples of the data protection process.

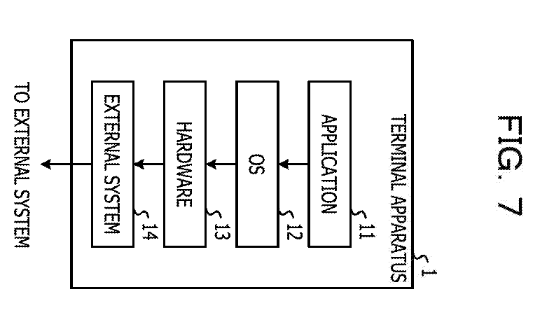

FIG. 7 through FIG. 9 illustrate functional configurations of the terminal apparatus 1.

In the terminal apparatus 1 of FIG. 7, a hypervisor 13 runs on the hardware 14 (physical resource) of the terminal apparatus 1, and generates or deletes a virtual machine. For example, when a virtual machine is generated in the terminal apparatus 1, the hypervisor 13 generates an OS 12 (hereinafter also referred to as a guest OS 12) thereon, and assigns part of the hardware 14 as virtual hardware of the virtual machine. When a virtual machine generated in the terminal apparatus 1 is to be deleted, the hypervisor 13 deletes the OS 12 generated thereon, and releases the virtual hardware of the virtual machine.

The hypervisor 13 of FIG. 7 directly runs on the hardware 14. Alternatively, the hypervisor 13 may be a hypervisor that runs on a host OS operating on the hardware 14. For example, the hypervisor 13 of FIG. 7 is not a hypervisor running on a host OS, but a hypervisor directly running on the hardware 14 (type 1 hypervisor). The hypervisor 13 may be a hypervisor running on the host OS directly operating on the hardware 14 (type 2 hypervisor).

The hypervisor 13 of the terminal apparatus 1 waits on standby until the command information storage timing as illustrated in FIG. 5 (no branch from S1). The command information storage timing is a timing when the command information 131 is stored on the information storage region 130. The command information storage timing may be a timing when the administrator inputs the command information 131 to the terminal apparatus 1. If it reaches the command information storage timing (yes branch from S1), the hypervisor 13 stores the command information 131 on the information storage region 130 (S2).

The application 11 may be malware (if the application 11 is infected with the malware). The hypervisor 13 stores in advance, as the command information 131, information that identifies each command that the malware may possibly transmit to the OS 12. For example, the hypervisor 13 stores as the command information 131 information that identifies a virtual machine (VM) detection command. The VM detection command is a command to determine whether an environment in which the malware operates is a virtual environment.

The hypervisor 13 determines whether the application 11 is malware (the application 11 is infected with the malware) by referencing contents of the command the application 11 has transmitted to the OS 12.

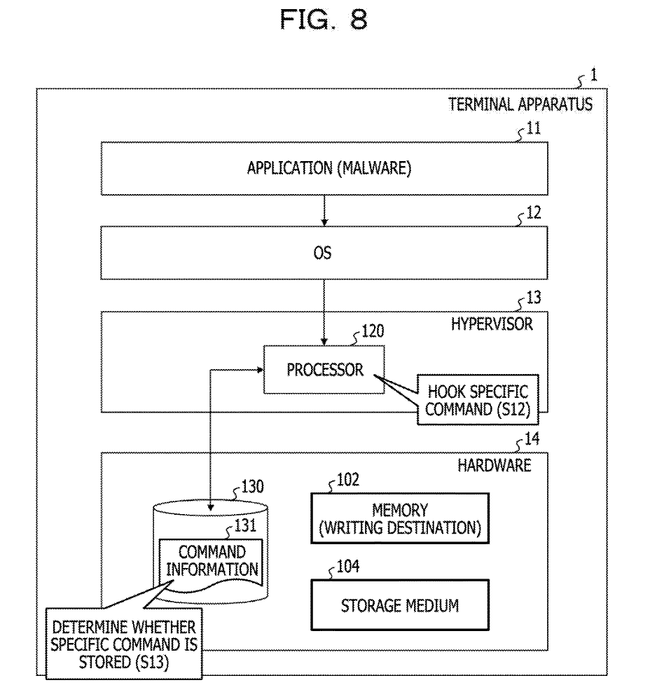

As illustrated in FIG. 6, the hypervisor 13 then waits on standby until the application 11 transmits the command to the OS 12 (no branch from S11). In response to detecting the command that has been transmitted from the application 11 to the OS 12 (yes branch from S11), the hypervisor 13 hooks the detected command (specific command) as illustrated in FIG. 8 (S12).

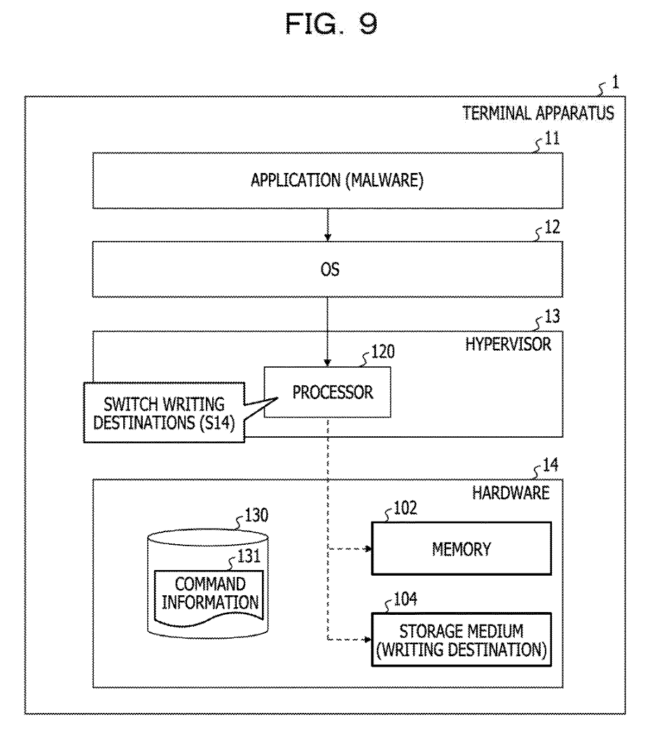

As illustrated in FIG. 8, the hypervisor 13 determines whether the information corresponding to the command hooked in S12 is included in the command information 131 stored on the information storage region 130 (S13). If the information corresponding to the hooked command is included in the command information 131 (yes branch from S13), the hypervisor 13 switches data writing hardware destinations from the hardware to the other hardware (S14). For example, as illustrated by arrow-headed broken lines of FIG. 9, the hypervisor 13 switches data writing hardware destinations from the memory 102 to the storage medium 104.

If a command having information included in the command information 131 is transmitted, the hypervisor 13 determines that the application 11 having transmitted the command may be malware itself, or may be infected with the malware. The terminal apparatus 1 switches data writing hardware destinations of the OS 12 from the memory 102 to the storage medium 104.

The hypervisor 13 stores on the information storage region 130 the command transmitted from the malware to the OS 12. The hypervisor 13 hooks the command transmitted from the application 11 to the OS 12. The hypervisor 13 determines whether the hooked command is stored on the information storage region 130. If the hooked command is stored on the information storage region 130, the hypervisor 13 switches data writing hardware destinations of the OS 12 from the hardware to the other hardware.

The hypervisor 13 reduces the possibility that the hardware before switching is operated by the malware (by the application 11 infected with the malware). The hypervisor 13 reduces damage, for example, damage that data stored on the hardware before switching is encrypted by the malware. The hypervisor 13 may protect the data stored on the hardware before switching from the malware.

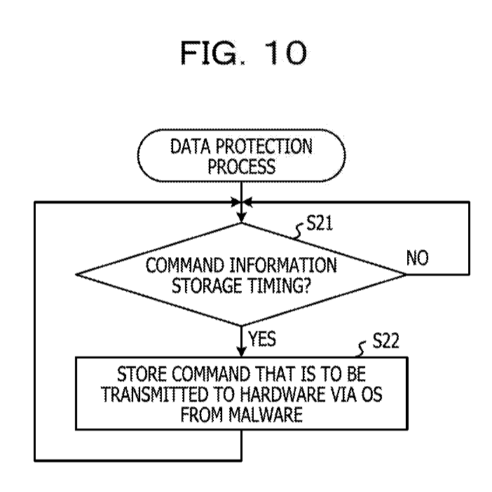

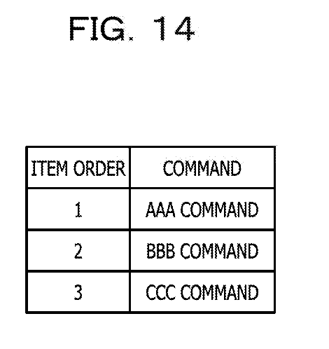

FIG. 10 through FIG. 13 are examples of the data protection process. FIG. 14 illustrates an example of the command information.

Referring to FIG. 10, the information management unit 111 waits on standby until the command information storage timing (no branch from S21). When it reaches the command information storage timing (yes branch from S21), the information management unit 111 stores the command information 131 on the information storage region 130 (S22).

FIG. 14 illustrates a specific example of the command information 131. The command information 131 of FIG. 14 includes an “item order” column that lists each piece of information included in the command information 131 to identify the information, and a “command” column that lists commands (VM detection commands) that may be possibly transmitted from the malware.

In the command information 131 of FIG. 14, an “AAA command” is set to be the information of the “command” at the “item order” 1, a “BBB command” is set to be the information of the “command” at the “item order” 2, and a “CCC command” is set to be the information of the “command” at the “item order” 3.

If the application 11 is malware, the information management unit 111 stores in advance on the information storage region 130 the command information 131 that identifies each command that is likely to be transmitted to the OS 12 by the malware.

The information management unit 111 works even if information identifying a command other than the VM detection command likely to be transmitted by the malware may be included in the command information 131. For example, the information management unit 111 works even if the command information 131 includes information identifying a debugger detection command. The debugger detection command is used for the malware to query whether an operational environment of the malware is on a program, such as a debugger. For this reason, the command determination unit 113 may detect the malware at a higher accuracy level.

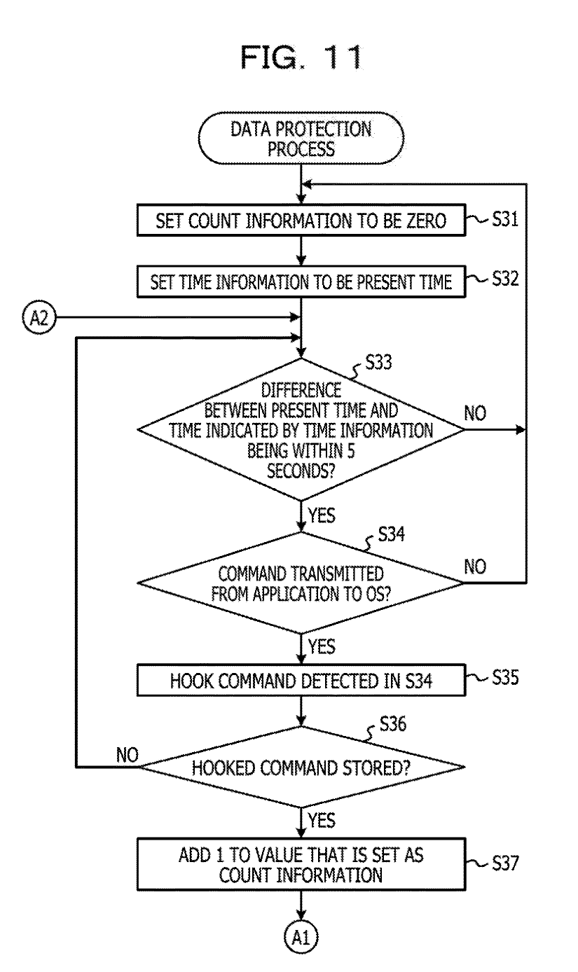

Referring to FIG. 11, the command determination unit 113 sets the count information 132 to be “0” (S31). The count information 132 is information indicating the number of times by which the application 11 has transmitted commands within a predetermined time period.

A command whose information is included in the command information 131 may be transmitted by the application 11 that is not infected with malware. Each time the application 11 transmits the command whose information is included in the command information 131, the data writing hardware destinations are switched. In such a case, the hypervisor 13 may not efficiently protect the data stored on the memory 102.

If the transmission count of the command whose information is included in the command information 131 exceeds a predetermined count within a predetermined time period, the hypervisor 13 switches data writing hardware destinations, based on the grounds that the application 11 is likely to be malware. The hypervisor 13 is thus able to efficiently protect the data stored on the memory 102.

The command determination unit 113 sets the present time in the time information 133 that stores time at a predetermined timing (S32).

The command determination unit 113 determines whether a difference between the present time and the time set in the time information 133 is within 5 seconds (S33). If the difference between the present time and the time set in the time information 133 is within 5 seconds (yes branch from S33), the command acquisition unit 112 determines whether a command has been transmitted from the application 11 to the OS 12 (S34). If the command acquisition unit 112 determines that the command has been transmitted from the application 11 to the OS 12 (yes branch from S34), the command acquisition unit 112 hooks the command detected in S34 (S35).

If the difference between the present time and the time set in the time information 133 has reached 5 seconds (no branch from S34 or no branch from S33), the command determination unit 113 performs the operations in S31 and subsequent steps again.

The command determination unit 113 determines whether information corresponding to the command hooked in the operation in S35 is included in the command information 131 stored on the information storage region 130 (S36). If the information corresponding to the command hooked in the operation in S35 is included in the command information 131 (yes branch from S36), the command determination unit 113 adds “1” to the value set as the count information 132 (S37).

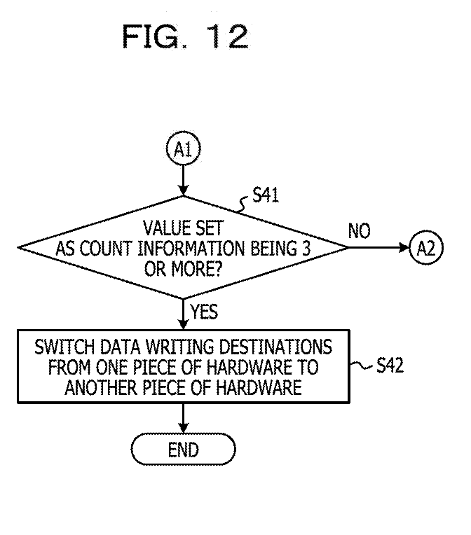

As illustrated in FIG. 12, the command determination unit 113 determines whether the value currently set as the count information 132 is equal to or above “3” (S41). If the value currently set as the count information 132 is equal to or above “3” (yes branch from S41), the hardware control unit 114 switches data writing hardware destinations of the OS 12 from the hardware to other hardware (S42). For example, the hardware control unit 114 switches data writing hardware destinations from the memory 102 to the storage medium 104.

The command determination unit 113 determines that the application 11 is likely to be malware (to be infected with the malware), not each time the command whose information is included is transmitted but if the command whose information is included in the command information 131 is transmitted more than three times within 5 seconds. For this reason, the hardware control unit 114 may switch data writing hardware destinations efficiently.

In the operation in S37, the command determination unit 113 may update the value set as the count information 132 in response to each command, for example, in response to each piece of information set in the “item order” column in the command information 131 of FIG. 14. In the operation in S41, the command determination unit 113 may determine whether the command that has been transmitted more than three times within 5 seconds is present among the commands whose information is included in the command information 131. The command determination unit 113 may efficiently switch data writing hardware destinations if the same command is transmitted by a predetermined number of times within a predetermined time period.

If the hypervisor 13 determines in S36 that the information corresponding to the hooked command is included in the command information 131, the hypervisor 13 may perform control to stop the operation of the OS 12. In this way, the hypervisor 13 may increase the probability that the data writing hardware destinations are switched before the malware encrypts the data stored on the hardware before switching.

If the hypervisor 13 determines in S36 that the information corresponding to the hooked command is included in the command information 131 stored on the information storage region 130, the hypervisor 13 may perform control to slow down the processing speed of the CPU 101 in the terminal apparatus 1. In this way, the hypervisor 13 may slow down the processing speed of the malware.

If the information corresponding to the hooked command is not included in the command information 131 (no branch from S36), the command determination unit 113 performs operations in S33 and subsequent steps again. If the value set as the count information 132 is not higher than “3” (no branch from S41), the command determination unit 113 performs operations in S33 and subsequent steps again.

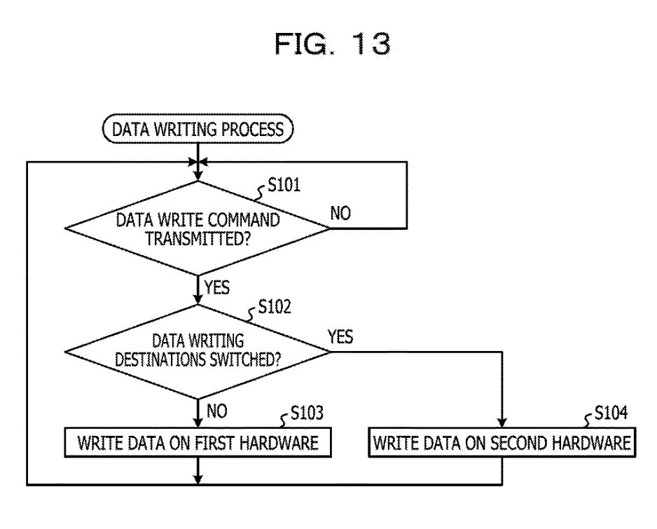

FIG. 13 illustrates a data writing process.

The data writing unit 115 waits on standby until the application 11 transmits a data writing command to the OS 12 (no branch from S101). If the data writing command is transmitted (yes branch from S101), the data writing unit 115 determines whether the data writing hardware destinations have been switched (S102).

If the data writing unit 115 determines that the data writing hardware destinations have not been switched (no branch from S102), the data writing unit 115 writes data on the hardware before switching (hereinafter referred to as first hardware). If the data writing unit 115 determines that the data writing hardware destinations have been switched (yes branch from S102), the data writing unit 115 writes the data on the hardware after switching (hereinafter referred to as second hardware).

If the hardware control unit 114 has switched the data writing hardware destinations of the OS 12, the data writing unit 115 reduces the possibility that the malware writes on the first hardware. For this reason, the hypervisor 13 may protect the data stored on the first hardware. In the operation in S103, the data writing unit 115 may write the data on both the first hardware and the second hardware.

The hypervisor 13 stores on the information storage region 130 the command the malware transmits to the OS 12. The hypervisor 13 hooks the command transmitted from the application 11 to the OS 12. The hypervisor 13 then determines whether the hooked command is stored on the information storage region 130. If the hooked command is stored on the information storage region 130, the hypervisor 13 switches the data writing hardware destinations of the OS 12 to the second hardware.

The hypervisor 13 may reduce or control the possibility that the first hardware is operated by the malware (by the application 11 infected with the malware). The hypervisor 13 may reduce or control the damage that the data stored on the first hardware is encrypted by the malware.

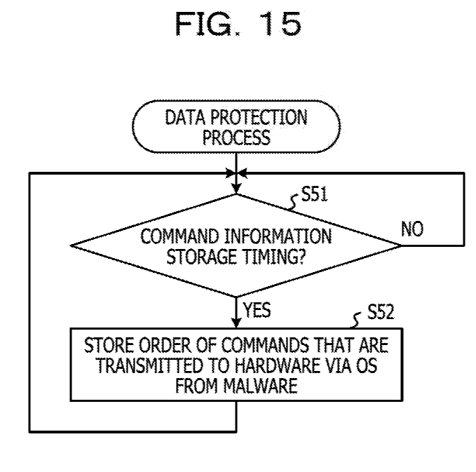

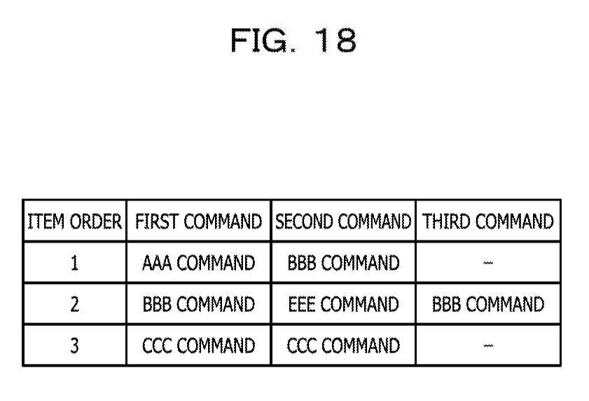

FIG. 15 through FIG. 17 illustrate examples of the data protection process. FIG. 18 illustrates an example of the command information.

If information corresponding to the order of multiple commands transmitted from the application 11 to the OS 12 is stored in the command information 131 in the data protection process illustrated in FIG. 15 through FIG. 17, the application 11 may be determined to be malware (to be infected with the malware).

If operational characteristics of the malware are obvious, the hypervisor 13 may differentiate at a higher accuracy level a command transmitted from the malware from a command transmitted from the application 11 not infected with the malware. For this reason, the hypervisor 13 may efficiently switch data writing hardware destinations of the OS 12.

The information management unit 111 waits on standby until the command information storage timing (no branch from S51) as illustrated in FIG. 15. When it reaches the command information storage timing (yes branch from S51), the information management unit 111 stores the command information 131 on the information storage region 130 (S52). The command information 131 is information corresponding to the command transmitted from the malware to the OS 12.

FIG. 18 illustrates a specific example of the command information 131. The command information 131 of FIG. 18 includes as columns an “item order” column identifying each piece of information included in the command information 131, and a “first command” column listing a command that may be transmitted from the malware. The command information 131 of FIG. 18 further includes as columns a “second command” column listing a command that may be transmitted by the malware subsequent to the command listed in the “first command” column, and a “third command” column listing a command that may be transmitted by the malware subsequent to the command listed in the “second command” column.

Information at an “item order” of 1 in the command information 131 of FIG. 18 includes an “AAA command” set as the “first command” and a “BBB command” set in the “second command”. Information at the “item order” of 1 in the command information 131 of FIG. 18 includes as the “third command” a symbol “−” indicating that no information is set. Information at an “item order” of 2 in the command information 131 of FIG. 18 includes the “BBB command” set as the “first command”, an “EEE command” set as the “second command”, and the “BBB command” as the “third command”. Information at an “item order” of 3 in the command information 131 of FIG. 18 includes a “CCC command” set as the “first command”, the “CCC command” set as the “second command”, and the symbol “−” as the “third command”.

If each of the “first command”, the “second command”, and the “third command” is transmitted consecutively by a predetermined number of times within a predetermined time period, the hypervisor 13 determines that each command has been transmitted by the malware. For example, the “BBB command”, the “EEE command”, and the “BBB command” are consecutively transmitted by the predetermined number of times within the predetermined time period, the hypervisor 13 determines that each command has been transmitted by the malware and that the malware is running on the OS 12. In this way, the hypervisor 13 may differentiate at a higher accuracy level the command transmitted by the malware from the command transmitted by the application 11 that is not affected with the malware.

The command information 131 of FIG. 18 includes three command columns that list information for the commands. Alternatively, the command information 131 may include two command columns that list information for the commands. The command information 131 of FIG. 18 may include four or more command columns that list information for the commands.

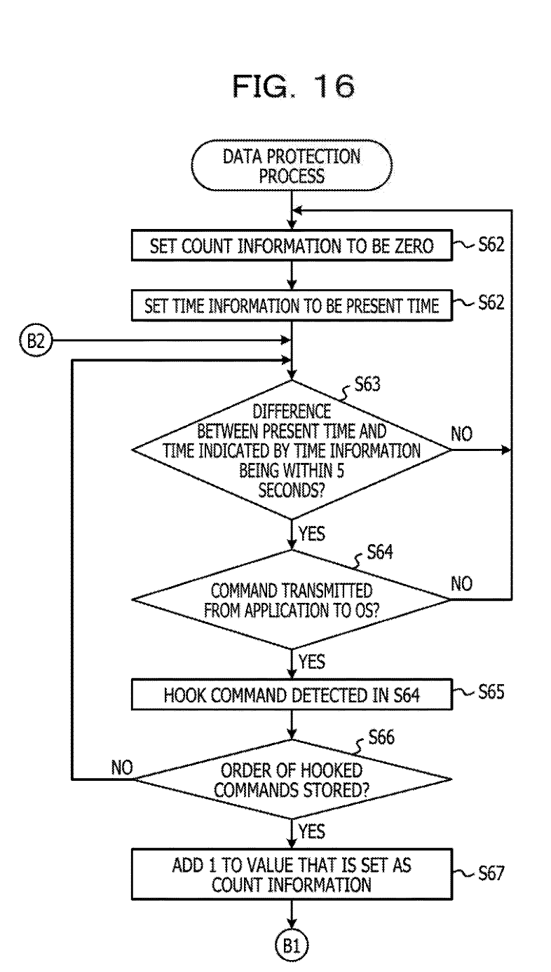

Referring to FIG. 16, the command determination unit 113 sets “0” as the count information 132 (S61). The command determination unit 113 also sets the present time for the time information 133 that stores time at a predetermined timing (S62).

The command determination unit 113 determines whether a difference between the present time and the time set as the time information 133 is within 5 seconds or not (S63). If the difference between the present time and the time set as the time information 133 is within 5 seconds (yes branch from S63), the command acquisition unit 112 determines whether a command has been transmitted from the application 11 to the OS 12 (S64). If the command acquisition unit 112 determines that a command has been transmitted from the application 11 to the OS 12 (yes branch from S64), the command acquisition unit 112 hooks the command detected in the operation in S64 (S65). When the difference between the present time and the time set as the time information 133 has reached 5 seconds (no branch from S64 or no branch from S63), the command determination unit 113 performs operations in S61 and subsequent steps.

The command determination unit 113 determines whether information corresponding to the order of the commands hooked in the operation in S65 is included in the command information 131 stored on the information storage region 130 (S66). If the information corresponding to the hooked command is included in the command information 131 (yes branch from S66), the command determination unit 113 adds “1” to the value set as the count information 132 (S67).

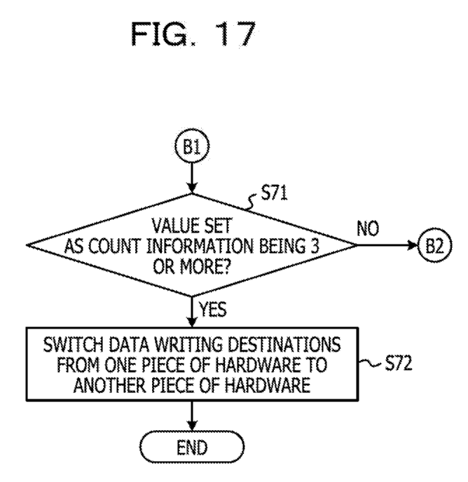

Referring to FIG. 17, the command determination unit 113 then determines whether the value currently set as the count information 132 is “3” or more (S71). If the value currently set as the count information 132 is “3” or more (yes branch from S71), the hardware control unit 114 switches data writing hardware destinations of the OS 12 to the second hardware (S72). For example, the hardware control unit 114 switches data writing hardware destinations from the memory 102 to the storage medium 104.

If the information corresponding to the hooked command is not included in the command information 131 (no branch from S66), or the value set as the count information 132 is not more than “3” (no branch from S71), the command determination unit 113 performs the operations in S63 and subsequent steps again.

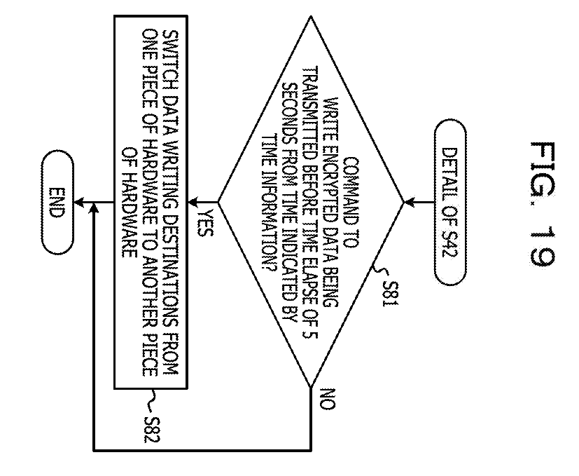

In the operation in S67, the command determination unit 113 may update the value set as the count information 132 at each command in the order of commands, in other words, may update the value set as the count information 132 on each piece of information set in the “item order” column of the command information 131 of FIG. 18. In the operation in S71, the command determination unit 113 determines whether the order of commands transmitted by three or more times within 5 seconds is one of the orders of commands whose information is included in the command information 131. If multiple commands are transmitted in the same order by the predetermined number of times within the predetermined time period, the command determination unit 113 may switch data writing hardware destinations. FIG. 19 illustrates the operation in S42 (operation in S72). The operation in S42 is described below.

If the value set as the count information 132 is “3” or more in S41 (yes branch from S41), the hardware control unit 114 determines, before 5 seconds elapses from the time indicated by the time information 133, whether an encrypted data writing command has been transmitted (S81). If the encrypted data writing command has been transmitted (yes branch from S81), the data writing hardware destination is switched to the second hardware (S82).

If the malware running on the terminal apparatus 1 is ransomware, the ransomware generates encrypted data by encrypting the data stored on the hardware 14. In this case, the ransomware transmits an encrypting data write request for the hardware 14 to the OS 12.

If the value set as the count information 132 is “3” or more, and the encrypted data writing command is transmitted from the application 11 to the OS 12, the hardware control unit 114 may switch data writing hardware destinations. In this way, the hardware control unit 114 may switch data writing hardware destinations at a higher accuracy level.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A non-transitory recording medium storing a data protection program causing a computer to perform a process, the process comprising:
storing, in a memory, a first command to be transmitted from a malware to an operating system;
hooking a second command that has been transmitted from an application to the operating system;
determining whether the second command is stored in the memory; and
switching a destination of writing data by the operating system from a first hardware to a second hardware when the second command is stored in the memory.

2. The non-transitory recording medium according to claim 1, wherein the second command is a command that requests information indicating whether the application is running on a virtual machine.

3. The non-transitory recording medium according to claim 1, wherein the first hardware is switched to the second hardware when the second command is hooked a number of times within a time period and the second command is stored in the memory.

4. The non-transitory recording medium according to claim 1, wherein the process further includes:
storing, in the memory, an order of a plurality of first commands that are transmitted from the malware to the operating system;
hooking a plurality of second commands that has been transmitted from the application to the operating system; and
switching from the first hardware to the second hardware when an order of the plurality of second commands which are hooked is stored in the memory.

5. The non-transitory recording medium according to claim 1, wherein the first hardware is switched to the second hardware when the plurality of second commands are hooked in a specific order a number of times within a time period and the specific order is stored in the memory.

6. The non-transitory recording medium according to claim 1, wherein the first hardware is switched to the second hardware when a request to write encrypted data has been transmitted from the application to the operating system.

7. A data protection method, comprising:
storing, in a memory, a first command to be transmitted from a malware to an operating system;
hooking, by a computer, a second command that has been transmitted from an application to the operating system;
determining whether the second command is stored in the memory; and
switching a destination of writing data by the operating system from a first hardware to a second hardware when the second command is stored in the memory.

8. The data protection method according to claim 7, wherein the second command is a command that requests information indicating whether the application is running on a virtual machine.

9. The data protection method according to claim 7, wherein the first hardware is switched to the second hardware when the second command is hooked a number of times within a time period and the second command is stored in the memory.

10. The data protection method according to claim 7, further comprising:
storing, in the memory, an order of a plurality of first commands that are transmitted from the malware to the operating system;
hooking a plurality of second commands that has been transmitted from the application to the operating system; and
switching from the first hardware to the second hardware when an order of the plurality of second commands which are hooked is stored in the memory.

11. The data protection method according to claim 7, wherein the first hardware is switched to the second hardware when the plurality of second commands are hooked in a specific order a number of times within a time period and the specific order is stored in the memory.

12. The data protection method according to claim 7, wherein the first hardware is switched to the second hardware when a request to write encrypted data has been transmitted from the application to the operating system.

13. A data protection apparatus, comprising:
a first memory that stores a program; and
a processor that preforms operations based on the program,
wherein the operations includes:
storing, in a second memory, a first command to be transmitted from a malware to an operating system;
hooking a second command that has been transmitted from an application to the operating system;
determining whether the second command is stored in the second memory; and
switching a destination of writing data by the operating system from a first hardware to a second hardware when the second command is stored in the second memory.

14. The data protection apparatus according to claim 13, wherein the second command is a command that requests information indicating whether the application is running on a virtual machine.

15. The data protection apparatus according to claim 13, wherein the first hardware is switched to the second hardware when the second command is hooked a number of times within a time period and the second command is stored in the second memory.

16. The data protection apparatus according to claim 13, wherein the operations includes:
storing, in the second memory, an order of a plurality of first commands that are transmitted from the malware to the operating system;
hooking a plurality of second commands that has been transmitted from the application to the operating system; and
switching from the first hardware to the second hardware when an order of the plurality of second commands which are hooked is stored in the second memory.

17. The data protection apparatus according to claim 13, wherein the first hardware is switched to the second hardware when the plurality of second commands are hooked in a specific order a number of times within a time period and the specific order is stored in the second memory.

18. The data protection apparatus according to claim 13, wherein the first hardware is switched to the second hardware when a request to write encrypted data has been transmitted from the application to the operating system.
